(19) United States
(12) Patent Application Publication
(10) Pub. No.: US 2010/0118240 A1
(43) Pub. Date: May 13, 2010

(54) COMPOSITE RETARDATION PLATE, METHOD FOR PRODUCTION THEREOF, COMPOSITE OPTICAL MEMBER, AND LIQUID CRYSTAL DISPLAY DEVICE

(76) Inventor: Yuichiro Kunai, Ehime (JP)

Correspondence Address: BIRCH STEWART KOLASCH & BIRCH, PO BOX 747, FALLS CHURCH, VA, 22040-0747, US

(21) Appl. No.: 12/439,991

(22) PCT Filed: Aug. 28, 2007
(86) PCT No.: PCT/JP2007/067106

§ 371 Date: Mar. 4, 2009

(30) Foreign Application Priority Data
Sep. 5, 2006 (JP) 2006-239979
Nov. 7, 2006 (JP) 2006-301252

(51) Int. Cl. G02F 1/13363; G02B 5/00; C09K 19/00; B05D 5/06; G02B 1/08

(52) U.S. Cl. 349/117; 428/454; 428/451; 428/414; 428/1.32; 427/164; 359/500

(57) ABSTRACT

Disclosed is a composite retardation plate which comprises a retardation plate composed of a transparent resin, a primer layer, and a coating retardation layer comprising an organic modified lay complex and a binder resin laminated in this order, wherein the primer layer is composed of a composition comprising a water-soluble organic metal compound selected from a water-soluble organic titanium compound and a water-soluble organic zirconium compound and a water-soluble resin. The composite retardation plate may further comprise a polarizing plate preferably laminated on the side of the resin retardation plate, thereby providing a composite optical member. The composite optical member may be combined with a liquid crystal cell to provide a liquid crystal display device.

### TECHNICAL FIELD

The present invention relates to a composite retardation plate to be laminated on a liquid crystal cell, and production thereof, and a composite optical member and a liquid crystal display, each comprising such a composite retardation plate. The present invention also relates to a technique for improving the water resistance of a composite retardation plate.

### BACKGROUND ART

In these years, liquid crystal displays as information-displaying devices such as mobile phones, personal digital assistants, monitors for computers and televisions have rapidly come into wide use, because of such advantages of the LCDs as low electric power consumption, low voltage operation, lightweight and slimness. With the progress of the LCD technologies, liquid crystal displays of various modes have been proposed. Under such circumstances, the problems of the liquid crystal displays in response speed, contrast, narrow viewing angle, etc. are now being overcome.

One of such LCDs is a vertical alignment (or VA) mode LCD in which rod-like liquid crystal molecules having positive or negative dielectric constant anisotropy are aligned vertically to a substrate. In such a vertical alignment mode, the liquid crystal molecules are aligned vertically to a substrate while they are not driven, and therefore, light passes through a liquid crystal layer without any change in polarization. When linearly polarizing plates are disposed on the upper and lower sides of such a liquid crystal panel so that their polarizing axes can be orthogonal to each other, the liquid crystal panel is seen to be substantially perfect black when viewed in front, and thus, a high contrast ratio can be obtained.

However, the VA mode liquid crystal display of this type in which only the polarizing plates are disposed on the liquid crystal cell suffers from light leakage which leads to a remarkable decrease in contrast ratio. This is because, when the liquid crystal display is viewed from an oblique direction, the axial angles of the disposed polarizing plates are deviated from 90° and the linear liquid crystal molecules in the cell exhibit birefringence.

To eliminate such light leakage, it is necessary to dispose an optical compensation film between the liquid crystal cell and each of the linearly polarizing plates. Therefore, conventionally, each one biaxial retardation plate is disposed between a liquid crystal cell and each of upper and lower polarizing plates; or one positively uniaxial retardation plate and one perfectly biaxial retardation plate are disposed on the upper and lower sides of a liquid crystal cell, respectively, or both the retardation plates are disposed on one side of the liquid crystal cell.

For example, JP-A-2001-109009 discloses a VA mode liquid crystal display in which an a-plate (i.e., a positively uniaxial retardation plate) and a c-plate (i.e., a perfectly biaxial retardation plate) are disposed between an upper polarizing plate and a liquid crystal cell and between a lower polarizing plate and the liquid crystal cell, respectively.

The positively uniaxial retardation plate is a film in which the ratio of its in-plane phase difference R₀ to its phase difference Rₜₕ in its thickness direction (i.e., R₀/Rₜₕ) is substantially 2. The perfectly biaxial retardation plate is a film in which the in-plane phase difference R₀ is substantially zero (0). In this regard, the in-plane phase difference R₀ and the phase difference Rₜₕ in the thickness direction are defined by the following equations (I) and (II), respectively:

R₀=(nx−ny)×d (I), and

Rₜₕ=[(nx+ny)/2−nz]×d (II),

wherein nx represents a refractive index of the film in the direction of an in-plane retarding axis; ny represents a refractive index of the film in the direction of an in-plane advancing axis (i.e., a direction orthogonal to the in-plane retarding axis); nz represents a refractive index in the thickness direction; and d represents a thickness of the film.

The positively uniaxial film has a relationship of nz≈ny, so that the ratio R₀/Rₜₕ is substantially 2 (R₀/Rₜₕ≈2). Despite a positively uniaxial film, the ratio R₀/Rₜₕ may vary within a range of about 1.8 to about 2.2, depending on the change of orienting conditions. Since the perfectly biaxial film has a relationship of nx≈ny, its in-plane phase difference is substantially zero (R₀≈0). The perfectly biaxial film is different (and smaller) only in the refractive index in the thickness direction, and thus is negatively uniaxial. Therefore, this film is called a film having an optical axis in a normal line direction, and thus it is also sometimes called a c-plate as described above.

As one example of the perfect biaxial film (c-plate) described above, a film composed of a coating layer which contains an organically modified clay complex is known. For example, JP-A-2005-338215 discloses the production of a composite retardation plate by laminating a coating retardation layer having a refractive index anisotropy on a retardation plate consisting of a transparent resin film oriented in-plane through a pressure-sensitive adhesive layer and furthermore disposing a pressure-sensitive adhesive layer on the surface of the coating retardation layer. JP-A-2005-338215 also discloses the lamination of a polarizing plate on the side of the resin retardation plate. JP-A-2006-10912 discloses a retardation plate which uses a urethane resin comprising an aliphatic diisocyanate as a binder and comprises a film of a composition containing such a binder and an organically modified clay complex and describes the formation of a composite polarizing plate by laminating such a retardation plate on a polarizing plate through a pressure-sensitive adhesive layer. Specifically, it discloses that the coating retardation layer is transferred on the pressure-sensitive adhesive layer side of a polarizing plate having a pressure-sensitive adhesive layer and the second pressure-sensitive adhesive layer is formed on the surface of the coating retardation layer.

However, the structures disclosed in JP-A-2005-338215 and JP-A-2006-10912 have the following disadvantage: since the coating retardation layer is sandwiched between the two pressure-sensitive adhesive layers, it is easily influenced by external stress. Therefore, stress is concentrated at the coating retardation layer, when an external physical force is applied to the composite retardation plate or the composite polarizing plate, resulting in that the coating retardation layer cracks, which is likely to lead to light leakage.

The present inventors found the following fact in the course of their researches to fabricate a composite retardation plate: that is, when a composite retardation plate is produced by laminating a retardation plate made of a transparent resin and a coating retardation layer having refractive index anisotropy each other, light leakage due to the cracking of the coating retardation layer, which tends to be caused by an external physical force, can be suppressed by using a primer layer in place of a pressure-sensitive adhesive layer which is conventionally disposed between the retardation plate and the coating retardation layer, and filed Japanese Patent Application No. 2006-225058. This primer layer can be formed by a method of applying a coating liquid for a primer layer on a substrate, and the coating liquid for a primer layer is preferably used in the form of an aqueous solution rather than an organic solvent solution in consideration of damages to the substrate. In the examples of the above-mentioned Japanese patent application, a coating liquid comprising a water-soluble polyamide epoxy resin and polyvinyl alcohol is used for forming the primer layer, and in this case, the polyamide epoxy resin functions as a curing agent which crosslinks polyvinyl alcohol. However, such a composite retardation plate obtained by laminating a retardation plate and a coating retardation layer each other through a primer layer, or a composite optical member obtained by laminating a polarizing plate on the side of the coating retardation layer of the composite retardation plate through a pressure-sensitive adhesive layer does not always have sufficient water resistance. For example, it has become apparent that the edge of the primer layer is partially dissolved or whitened, when the composite retardation plate or composite optical member is immersed in warm water.

After further researches, the present inventors have found that, in a composite retardation plate prepared by laminating a coating retardation layer with refractive index anisotropy on a retardation plate made of a transparent resin through a primer layer, a composite retardation plate having excellent water resistance is obtained, when the primer layer is formed using a composition comprising a water-soluble resin and a curing agent comprising a water-soluble organic titanium compound or a water-soluble organic zirconium compound, which is highly reactive with the water-soluble resin.

Therefore, one object of the present invention is to provide a composite retardation plate which hardly produces fine cracks in the coating retardation layer when the composite retardation plate is laminated on a liquid crystal cell, which can suppress the occurrence of light leakage and also which is superior in water resistance, and to provide a process for producing the same.

Another object of the present invention is to provide a composite optical member which is produced by laminating an optical layer having other optical function such as a polarizing plate on this composite retardation plate and which can suppress light leakage when laminated on a liquid crystal cell and also which is superior in water resistance.

A further object of the present invention is to apply this composite optical member to a liquid crystal display.

### DISCLOSURE OF THE INVENTION

Accordingly, the present invention provides a composite retardation plate comprising a retardation plate made of a transparent resin, a primer layer, and a coating retardation layer that comprises an organically modified clay complex and a binder resin, which are laminated in this order, wherein the primer layer is formed of a composition comprising a water-soluble resin and a water-soluble organic metal compound selected from the group consisting of water-soluble organic titanium compounds and water-soluble organic zirconium compounds.

Further, the present invention provides a process for producing a composite retardation plate, in which, a coating liquid for a primer layer, which is prepared by dissolving a water-soluble resin and a water-soluble organic metal compound selected from the group consisting of water-soluble organic titanium compounds and water-soluble organic zirconium compounds in a solvent comprising water, is applied onto the surface of a retardation plate made of a transparent resin, and the solvent is removed therefrom to form a primer layer, and a coating liquid for a coating retardation layer, which contains an organically modified clay complex and a binder resin in an organic solvent, is applied onto the surface of the primer layer, and the solvent is removed therefrom to form a coating retardation layer.

Furthermore, the present invention provides a composite optical member comprising an optical layer having other optical function, such as a polarizing plate or the like, laminated on the above-described composite retardation plate. In addition, the present invention provides a liquid crystal display comprising this composite optical member disposed on at least one surface of a liquid crystal cell.

### BRIEF DESCRIPTION OF THE DRAWINGS

FIG. 1 shows a schematic sectional view of a composite retardation plate, illustrating the structure thereof.

FIG. 2 shows a schematic sectional view of a composite optical member, illustrating the structure thereof.

### DESCRIPTION OF REFERENCE NUMERALS

10: Composite retardation plate
11: Retardation plate made of a transparent resin
12: Primer layer
14: Coating retardation layer
20: Composite optical member
21: Optical layer having other optical function
22: Pressure-sensitive adhesive layer

### BEST EMBODIMENTS FOR CARRYING OUT THE INVENTION

Hereinafter, the embodiments of the present invention will be described in detail with reference to the accompanying drawings.

### (Composite Retardation Plate)

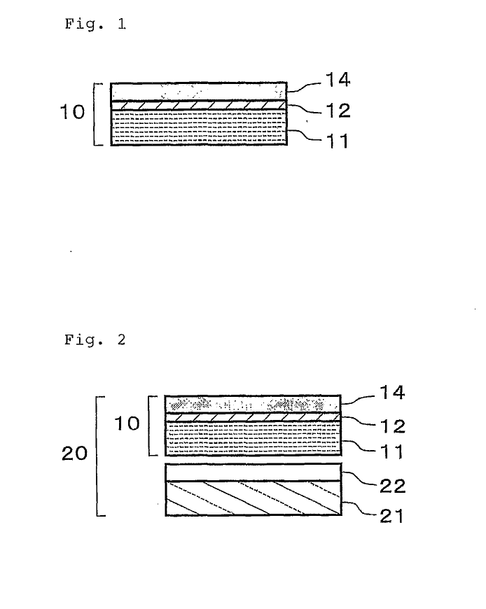

As shown in FIG. 1, a composite retardation plate 10 is fabricated by laminating a retardation plate 11 made of a transparent resin, a primer layer 12, and a coating retardation layer 14 in this order.

The retardation plate 11 consists of a plate which is made of a transparent resin and oriented in its plane. The resin used may be one having excellent transparency and optical uniformity, and an oriented transparent film made of a thermoplastic resin is preferably used from the viewpoint of easiness to form a film having an orientation property. Specific examples of the thermoplastic resin include polycarbonates, polyarylates, polysulfones, polyethersulfones, cellulose resins, polyolefin resins comprising, as main monomers, olefins such as propylene and ethylene, and cyclic polyolefin resins comprising, as main monomers, cyclic olefins such as norbornene. It is also possible to use, as the retardation plate 11, a transparent resin plate of a cellulose resin on which a coating layer of a liquid crystalline material is formed so as to cause a phase difference in the resin plate.

The in-plane phase difference of the resin retardation plate 11 may be appropriately selected within a range of about 30 to about 300 nm in accordance with the end use of a composite retardation plate. When a composite retardation plate is used in, for example, a relatively small and compact liquid crystal display for a mobile phone or a personal digital assistant, it is advantageous to use a quarter wavelength plate as the resin retardation plate 11.

The primer layer 12 is formed of a transparent resin by coating. While the term “primer” generally means an undercoating, the primer layer 12 in the present invention functions as an undercoating layer for the retardation layer 14 formed by coating. The presence of the primer layer 12 is effective to prevent the influence of an organic solvent in a coating liquid on the retardation plate, even when the coating liquid for the coating retardation layer 14 is directly applied to the primer layer. The primer layer 12 comprises a resin which does not show such high elasticity as a pressure-sensitive adhesive.

In general, a solution in an organic solvent is often used as a coating liquid for forming a primer layer. However, when such a solution in an organic solvent is applied onto the objective retardation plate 11 in the present invention, the solution often causes the swelling and erosion of the resin retardation plate 11, which often affect the optical characteristics of the retardation plate 11. Therefore, the primer layer 12 is formed using a coating liquid containing water as the solvent, which is a non-solvent for common resins. It is necessary to use a solvent comprising water, but it is possible to add a water-soluble organic solvent such as alcohols in order to adjust the viscosity or surface tension of the coating liquid. Examples of the alcohols include methanol, ethanol, 1-propanol, 2-propanol, 1-butanol, ethylene glycol, etc.

A water-soluble resin is used for the primer layer 12. Examples of the water-soluble resin include a polyvinyl alcohol resin, a water-soluble acrylic resin, etc. Among them, the polyvinyl alcohol resin is preferably used. The polyvinyl alcohol resin may be a partially saponified polyvinyl alcohol or a fully saponified polyvinyl alcohol, or a modified polyvinyl alcohol resin such as a polyvinyl alcohol modified with an anion such as a carboxyl group, an acetoacetyl group-modified polyvinyl alcohol, a methylol group-modified polyvinyl alcohol, an amino group-modified polyvinyl alcohol or the like. Suitable commercially available polyvinyl alcohol resins are “PVA-403” (trade name) which is a partially saponified polyvinyl alcohol and “KL-506” (trade names) which is an anion-modified polyvinyl alcohol, both sold by KURARAY CO., LTD. The details of these polyvinyl alcohols manufactured by KURARAY CO., LTD. are described as “KURARAY POVAL” in the POVAL resin-specialized site <URL:http://www.poval.jp/japan/poval/topics/index.html> (access date: Nov. 2, 2006).

The water-soluble resins such as polyvinyl alcohol resins should be crosslinked using a curing agent in order to enhance water resistance since the resins as such have low water resistance because of their water-solubility. For crosslinking the water-soluble resin, a method for applying a coating liquid for a primer layer to which a curing agent capable of crosslinking the water-soluble resin has been added may be employed. In this case, a reaction of the water-soluble resin with the curing agent predominantly proceeds by removing the solvent. When a curing agent having a higher reactivity with the water-soluble resin is used, the resulting primer layer has better water resistance since a crosslinking density after the reaction increases.

Consequently, according to the present invention, a water-soluble organic metal compound selected from the group consisting of water-soluble organic titanium compounds and water-soluble organic zirconium compounds is used as a curing agent for the water-soluble resin. Accordingly, a composite retardation plate having good water resistance can be obtained. The water-soluble organic titanium compounds and the water-soluble organic zirconium compounds referred to herein are compounds having at least one structure in which an organic group is directly bonded with the titanium or zirconium atom or an organic group is bonded with the titanium or zirconium atom through an oxygen atom or a nitrogen atom, in a molecule, and thereby having water-solubility. The organic group means a functional group containing at least carbon atom(s), and may be, for example, an alkyl group, an alkoxy group, an acyl group, an amino group or the like. Further, the bond does not necessarily mean only a covalent bond but it may include a coordinate bond based on the coordination of a chelate compound. As described above, the solvent of the coating liquid for a primer layer is preferably water alone or a mixed solvent of water and a small amount of an organic solvent. From this viewpoint, a water-soluble organic titanium compound or a water-soluble organic zirconium compound is used.

Typical examples of the water-soluble organic titanium compound and the water-soluble organic zirconium compound include compounds having the following structures:

(HO)₂Ti[OCH(CH₃)COOH]₂ (1)

(C₃H₇O)₂Ti[OCH₂CH₂N(CH₂CH₂OH)₂]₂ (2)

(HO)₂Zr[OCH(CH₃)COOH]₂ (3)

(C₃H₇O)₂Zr[OCH₂CH₂N(CH₂CH₂OH)₂]₂ (4)

Suitable examples of commercially available water-soluble organic titanium compounds include “Orgatics TC-310”, “Orgatics TC-315”, “Orgatics TC-300” and “Orgatics TC-400” (all trade names) manufactured by Matsumoto Pharmaceutical Manufacture Co., Ltd. Examples of the commercially available water-soluble organic zirconium compounds include “Orgatics ZB-400” (trade name) manufactured by Matsumoto Pharmaceutical Manufacture Co., Ltd. With respect to these commercialized products, chemical abbreviations referred to by the manufacturer, their chemical structures and their concentrations are shown below.

“Orgatics TC-310”: chemical abbreviation referred to by the manufacturer “titanium lactate”; its chemical structure is expressed by the above formula (1); a solution containing 44% by weight of the active component, 40% by weight of isopropyl alcohol and 16% by weight of water.

“Orgatics TC-315”: chemical abbreviation referred to by the manufacturer “titanium lactate”; its chemical structure is expressed by the above formula (1); a solution containing 44% by weight of the active component and 56% by weight of water.

“Orgatics TC-300”: chemical abbreviation referred to by the manufacturer “titanium lactate”; its chemical structure is expressed by the above formula (1); a solution containing 42% by weight of the active component, 38% by weight of isopropyl alcohol and 20% by weight of water.

“Orgatics TC-400”: chemical abbreviation referred to by the manufacturer “titanium triethanolaminate”; its chemical structure is expressed by the above formula (2); a solution containing 80% by weight of the active component and 20% by weight of isopropyl alcohol.

“Orgatics ZB-400”: chemical abbreviation referred to by the manufacturer “zirconium compound”; its chemical structure is unknown except that it is a water-soluble organic zirconium compound because the manufacturer does not announce any chemical structure; a solution containing 30% by weight of the active component and 70% by weight of water.

The proportions of the water-soluble resin and the water-soluble organic metal compound to be used for forming the primer layer 12 may be appropriately determined within a range of the organic metal compound of about 0.1 to about 200 parts by weight per 100 parts by weight of the water-soluble resin depending on the kinds of the water-soluble resin or the kinds of the organic metal compound. The amount of the water-soluble organic metal compound is particularly preferably selected from a range of about 0.1 to about 100 parts by weight per 100 parts by weight of the water-soluble resin. The organic metal compound has an effect of improving the water resistance of the primer layer when used in a relatively small amount of about 0.1 to about 5 parts by weight per 100 parts by weight of the water-soluble resin, but the organic metal compound has an improved effect of improving the water resistance by compounding it in a large amount of about 5 to about 100 parts by weight.

As described above, according to the present invention, the primer layer 12 is formed of a composition comprising a water-soluble resin and a water-soluble organic metal compound selected from the group consisting of water-soluble organic titanium compounds and water-soluble organic zirconium compounds. This composition may further contain other curing agent besides the water-soluble organic metal compound described above. By the use of the composition in combination with the other curing agent, a curing rate of a coated film can be controlled, or an adhesion force between the retardation plate 11 as a substrate and the coating retardation layer 14 can be controlled.

The other curing agent to be used in combination is not particularly limited, and suitable examples thereof include water-soluble epoxy resins. An example of the water-soluble epoxy resin is a polyamide epoxy resin which is obtained by a reaction between epichlorohydrin and a polyamidepolyamine which is obtained by reacting polyalkylenepolyamine such as diethylenetriamine or triethylenetetramine with a dicarboxylic acid such as adipic acid. Examples of commercially available polyamide epoxy resins include “SUMIREZ RESIN 650(30)” and “SUMIREZ RESIN 675” (both trade names) manufactured by Sumika Chemtex Co., Ltd.

When the water-soluble organic metal compound is used in combination with other curing agent, for example, the water-soluble epoxy resin, the amount of the other curing agent may be appropriately determined within a range of about 1 to about 20 parts by weight per 100 parts by weight of the water-soluble resin. The sufficient amount of the entire curing agents including the water-soluble organic metal compound is up to about 100 parts by weight per 100 parts by weight of the water-soluble resin, and the amount is preferably within a range of about 1 to about 50 parts by weight, and more preferably within a range of about 1 to about 30 parts by weight since, in the case of the concurrent use of the other curing agent described above, on one hand, the effect of the concurrent use can arise, and on the other hand, if the total amount of the other curing agent and the water-soluble organic metal compound is large, a possibility that precipitates may form in the coating liquid cannot be denied depending on the compatibility of the other curing agent with the water-soluble organic metal compound.

The coating liquid for a primer layer described above, which comprises a water-soluble organic metal compound and a water-soluble resin and may further comprise optionally other component such as the other curing agent, is preferably adjusted so as to have a solid content of about 1 to 25% by weight. The thickness of the primer layer 12 is preferably from about 0.1 to about 10 μm, and more preferably from about 0.5 to about 10 μm.

The coating retardation layer 14 is formed on the primer layer 12. The coating retardation layer 14 is a layer formed by evaporating an organic solvent from a coating liquid which contains an organically modified clay complex and a binder resin in an organic solvent. The organically modified clay complex herein used is a complex of an organic substance and a clay mineral. Specifically, such a complex is obtained by compounding a clay mineral having a layered structure with an organic compound, and it is dispersible in an organic solvent. Examples of the clay mineral having a layered structure include smectite clays and swelling mica, which can be complexed with an organic compound because of their cation-exchangeability. Above all, the smectite clays are preferable, because they also have superior transparency. Examples of the smectite clays include hectorite, montmorillonite, bentonite, etc. Among them, chemically synthesized clay minerals are preferable, since they contain fewer impurities and have superior transparency. Particularly preferable is synthesized hectorite having a controlled smaller particle size, because the use thereof is effective to suppress the scattering of visible rays.

Examples of the organic compound to be complexed with the clay mineral include a compound reactive with the oxygen atom or the hydroxyl group of the clay mineral, and an ionic compound exchangeable with an exchangeable cation. There is no limit on the selection of the organic compound, as long as the use of such a compound allows the organically modified clay complex to be swollen or dispersed in an organic solvent. Specific examples of the organic compound include nitrogen-containing compounds, and the like. Examples of the nitrogen-containing compounds include primary, secondary or tertiary amines, quaternary ammonium compounds, and the like. Among them, the quaternary ammonium compounds are preferable, because they are easily ion-exchanged with cations. Examples of the quaternary ammonium compounds include those having a long chain alkyl group, those having an alkyl ether chain, and the like. Among them, quaternary ammonium compounds having a long chain alkyl group with 6 to 30 carbon atoms, particularly 6 to 10 carbon atoms, and quaternary ammonium compounds having a —(CH₂CH(CH₃)O)ₙH group or a —(CH₂CH₂CH₂O)ₙH group, wherein n is a number of 1 to 50, particularly 5 to 30 are preferable.

The organically modified clay complex often contains chlorine-containing compounds as impurities because of its various auxiliary materials for use in the production thereof. When the organically modified clay compound containing a large amount of such chlorine-containing compounds is used, the chlorine-containing compounds tend to bleed out from the film formed as the coating retardation layer. In such a case, the adhesion force of the pressure-sensitive adhesive significantly decreases with time, when the coating retardation layer is laminated on a liquid crystal cell glass through the pressure-sensitive adhesive layer. To overcome this problem, it is preferable to remove the chlorine compounds by washing the organically modified clay complex, and if the organically modified clay complex is contained in an organic solvent in such a state that the content of chlorine contained therein is adjusted to 2,000 ppm or less, the adhesion force of the pressure-sensitive adhesive can be prevented from decreasing. The chlorine compounds can be removed from the organically modified clay compound by washing with water.

Two or more kinds of organically modified clay complexes may be used in combination. Suitable commercially available organically modified clay complexes are complexes of quaternary ammonium compounds and synthesized hectorites available under the trade names of “LUCENTITE STN” and “LUCENTITE SPN” manufactured by CO-OP CHEMICAL CO., LTD.

The organically modified clay complex dispersible in an organic solvent is used in combination with a binder resin from the viewpoints of easiness of coating to the primer layer 12, exhibition of optical characteristics and dynamical characteristics. As the binder resin to be used in combination with the organically modified clay complex, preferably, binder resins soluble in an organic solvent such as toluene, xylene, acetone and ethyl acetate, particularly, binder resins having a glass transition temperature lower than room temperature (about 20° C. or lower) are used. Preferably, a hydrophobic binder resin is used in order to obtain sufficient resistance to moist and heating and good handling properties, which are required for the composite retardation plate to be applied to a liquid crystal display device. Examples of such a preferable binder resin include polyvinylacetal resins such as polyvinylbutyral and polyvinylformal, cellulose resins such as cellulose acetate butyrate, acrylic resins such as butyl acrylate, urethane resins, methacrylic resins, epoxy resins and polyester resins, etc.

Suitable commercially available binder resins are an aldehyde modified resin of polyvinyl alcohol sold under the trade name of “Denka Butyral #3000-K” manufactured by DENKI KAGAKU KOGYO KABUSHIKI KAISHA, an acrylic resin sold under the trade name of “ALON S1601” manufactured by TOAGOSEI CO., LTD., an isophorone diisocyanate-based urethane resin sold under the trade name of “SBU Lacquer 0866” manufactured by Sumika Bayer Urethane Co., Ltd., etc.

The weight ratio of the organically modified clay complex dispersible in an organic solvent to the binder resin is from 1:2 to 10:1, particularly from 1:1 to 2:1. This range of the weight ratio is preferable to improve the dynamic properties such as the prevention of cracking of the layer comprising the organically modified clay complex and the binder resin.

The organically modified clay complex and the binder resin are applied onto the primer layer 12 in the form of a coating liquid for a coating retardation layer which contains them in an organic solvent. Generally, the binder resin is dissolved in the organic solvent, while the organically modified clay complex is dispersed in the organic solvent. The solid content of this coating liquid is not limited, as long as the prepared coating liquid does not form any gel or not become clouded to cause some problem in practical use of the preparation thereof. However, the organically modified clay complex and the binder resin are usually used so that the total solid content is about 3 to about 15% by weight. An optimal solid content varies with the kinds of the organically modified clay complex and the binder resin, and with their composition ratio, and therefore, the optimal solid concentration is selected in accordance with their compositions in each case. Further, additives such as a viscosity modifier for improving the coating ability for film-formation, a crosslinking agent for further improving the hydrophobicity and/or durability, etc. may be added to the coating liquid.

The refractive index anisotropy of the coating retardation layer in its thickness direction is represented by the phase difference Rₜₕ in the thickness direction, defined by the above-described equation (II). This value is calculated from a phase difference value R₄₀ measured when the in-plane lag axis as a tilt axis is inclined to an angle of 40°, and from an in-plane phase difference value R₀. That is, the phase difference value Rₜₕ in the thickness direction, determined by the equation (II), can be calculated as follows: the in-plane phase difference value R₀, the phase difference value R₄₀ found when the lag axis as the tilt axis is inclined to an angle of 40°, the thickness d of the film and an average refractive index n₀ of the film are used to find the values of nx, ny and nz by the following numerical equations (III) to (V), and these found values are substituted in the above-described equation (II):

R₀=(nx−ny)×d (III),

R40=(nx−ny′)×d/cos(φ) (IV), and

(nx+ny+nz)/3=n₀ (V),

wherein φ and ny′ are calculated by the following equations:

φ=sin⁻¹[sin(40°)/n0], and

ny′=ny×nz/[ny²×sin²(φ)+nz²×cos²(φ)]^{1/2}.

Preferably, the phase difference Rₜₕ of the coating retardation layer in its thickness direction is appropriately selected within a range of about 40 to about 500 nm, in accordance with the end use thereof and particularly the characteristics of a liquid crystal cell. The phase difference Rₜₕ in the thickness direction is advantageously 50 nm or more, and is advantageously 400 nm or less.

### (Process for Producing Composite Retardation Plate)

Next, a process for producing the composite retardation plate 10 is explained. Firstly, a coating liquid for a primer layer, which is prepared by dissolving a water-soluble resin and a water-soluble organic metal compound selected from the group consisting of water-soluble organic titanium compounds and water-soluble organic zirconium compounds in a solvent comprising water, is applied onto the surface of the retardation plate 11 made of a transparent resin. This coating liquid may contain the other component, for example, the curing agent other than the above-mentioned water-soluble organic metal compound, as described above. The coating method employed for applying the coating liquid for a primer layer is not particularly limited, and any of known coating methods such as a direct gravure method, a reverse gravure method, a die coating method, a comma coating method, a bar coating method or the like may be employed.

After the coating liquid for a primer layer is applied, the solvent comprising water is removed from the coating liquid layer to form the primer layer 12. The removal of the solvent for forming the primer layer 12 is carried out by heating the coating liquid layer at an appropriate temperature to evaporate the solvent. In this step, the solvent is evaporated usually by heating for several minutes depending on a temperature.

It is also effective for improving water resistance to accelerate curing of the primer layer by further subjecting the dried primer layer to thermal aging. In the case of employing thermal aging, when an aging temperature is too low, no aging effect is achieved. When the aging temperature is too high, there is a possibility that dimensional changes and/or degradation of a film may be caused. Therefore, the aging temperature is preferably selected within a range of about 30 to about 80° C. An aging time is preferably about 1 to about 7 days. This thermal aging may be carried out at any stage before a finished composite retardation plate is obtained and after the coating liquid for a primer layer is applied and then the solvent is removed therefrom.

For example, the primer layer is subjected to thermal aging after the coating liquid for a primer layer is applied and the solvent is removed therefrom, and thereafter a coating retardation layer is formed on the primer layer. Alternatively, the coating liquid for a primer layer is applied and the solvent is removed therefrom, and thereafter, a coating retardation layer is formed on the dried primer layer, and then the coating retardation layer is subjected to thermal aging.

Onto the surface of the primer layer 12 thus obtained, a coating liquid for a coating retardation layer, which comprises an organically modified clay complex and a binder resin contained in an organic solvent, is applied. This coating liquid may contain various other additives if necessary, as described above.

Preferably, the water content of the coating liquid for a coating retardation layer is adjusted to from 0.15 to 0.35% by weight when measured with a Karl Fischer's moisture meter. When the water content exceeds 0.35% by weight, a phase separation occurs in a water-insoluble organic solvent, and the coating liquid tends to be separated into two phases. On the other hand, when the water content is less than 0.15% by weight, the resulting coating retardation plate formed of such a coating liquid tends to have a higher haze value. Although there are various moisture content-measuring methods such as a drying method, a Karl Fischer's method, a dielectric method, and the like, the present invention employs the Karl Fischer's method which is simple and capable of measuring a trace quantity.

While there is no limitation in selecting a method for adjusting the water content of the coating liquid for a coating retardation layer in the above range, the addition of water to the coating liquid is a simple and preferable method. Merely mixing of an organic solvent, an organically modified clay complex and a binder resin as used in the present invention by a conventional method hardly leads to a water content of 0.15% by weight or more. Therefore, the water content is preferably adjusted to a value within the above range by adding a small amount of water to the coating liquid comprising the mixture of the organic solvent, the organically modified clay complex and the binder resin. Water may be added at any time during a step for preparing the coating liquid, and the timing for addition of water is not limited. Preferably, a predetermined amount of water is added after the sampling of the coating liquid for measurement of the water content thereof after a certain time elapsed in the course of the preparation of the coating liquid, because this method makes it possible to control the water content with good reproducibility and accuracy. The amount of water added is sometimes not equal to a result measured with the Karl Fischer's moisture meter, because of a possible interaction (for example, adsorption) between a part of water and the organically modified clay complex. It is, however, ensured to keep lower the haze value of the resultant coating retardation plate by maintaining the water content measured with the Karl Fischer' moisture meter to from 0.15 to 0.35% by weight.

The coating method employed for formation of the coating retardation layer 14 is not particularly limited, and any of known coating methods such as a direct gravure method, a reverse gravure method, a die coating method, a comma coating method, a bar coating method or the like may be employed. After the coating liquid for a coating retardation layer is applied, the solvent is removed therefrom to form the coating retardation layer 14. The removal of the solvent for forming the coating retardation layer 14 is also carried out by heating the applied coating liquid for a coating retardation layer to an appropriate temperature to evaporate the solvent.

### (Composite Optical Member)

An optical layer which exhibits other kind of optical function such as a polarizing plate or the like is laminated on one surface of the composite retardation plate to fabricate a composite optical member. FIG. 2 shows an example of the layer structure of the composite optical member as the schematic sectional view thereof. In this example, an optical layer 21 which exhibits other kind of optical function is laminated on the side of the retardation plate 11 made of a transparent resin in the composite retardation plate 10 shown in FIG. 1, to fabricate a composite optical member 20. For example, a pressure-sensitive adhesive is used for the lamination of both of them, and this is shown as a pressure-sensitive adhesive layer 22 in FIG. 6. Preferably, the optical layer 21 which exhibits other kind of optical function includes, at least, a polarizing plate, and additionally may include conventional members for use in the fabrication of a liquid crystal display, etc., such as a luminance-improving film and so on.

A polarizing plate as other optical layer 21 transmits a linearly polarized light ray which has an oscillating face in one in-plane direction, and absorbs a linearly polarized light ray which has an oscillating face in a direction orthogonal to the above one in-plane direction.

In concrete, there can be used a polarizer which comprises a polyvinyl alcohol film having dichroic pigments adsorbed and aligned thereon and which has protective film(s) laminated on at least one side (i.e., one side or both sides) thereof. Examples of the polarizer include an iodine type polarizer using iodine as a dichroic pigment and a dye type polarizer using a dichroic organic dyestuff, both of which may be used in the present invention. As the protective film, there is used a cellulose resin such as triacetyl cellulose, a cyclic polyolefin resin comprising, as a main monomer, a cyclic olefin such as norbornene or the like. When other optical layer 21 includes a polarizing plate, it is preferable to laminate the other optical layer 21 including this polarizing plate, on the side of the retardation plate 11 of the composite retardation plate 10, as shown in FIG. 2.

When a pressure-sensitive adhesive is used for the lamination of the other optical layer 21, the pressure-sensitive adhesive comprises, as a base polymer, an acrylic polymer, a silicone-based polymer, a polyester, a polyurethane, a polyether or the like. Above all, it is preferable to select and use an adhesive such as an acrylic pressure-sensitive adhesive, which is superior in optical transparency and is capable of retaining suitable wettability and a cohesive force, and which is superior in adhesion to a substrate, having weather resistance and heat resistance, and which is free from any problem relative to peeling such as floating and peeling under heating or humidifying conditions. For an acrylic pressure-sensitive adhesive, an acrylic copolymer prepared by polymerizing an alkyl ester of an acrylic acid which has an alkyl group having 20 or less carbon atoms, such as a methyl or ethyl group or a butyl group, with a functional group-containing acrylic monomer comprising a (meth)acrylic acid or a hydroxyethyl (meth)acrylate to have a weight-average molecular weight of 100,000 or more and a glass transition temperature of preferably 25° C. or lower, more preferably 0° C. or lower is useful as the base polymer.

### (Liquid Crystal Display)

The composite optical member 20 shown in FIG. 2 is disposed on at least one side of a liquid crystal cell to fabricate a liquid crystal display. Alternatively, such composite optical members may be disposed on both sides of the liquid crystal cell. When the composite optical member is disposed on one side of the liquid crystal cell, another polarizing plate is disposed on the other side of the liquid crystal cell, optionally through a retardation plate. As the liquid crystal cell, a vertical alignment (or VA) mode liquid crystal cell is preferable as described in the part of Prior Art. Furthermore, the composite retardation plate or the composite optical member produced according to the present invention can effectively function relative to other mode liquid crystal cell such as a bend alignment (ECB) mode liquid crystal cell.

Hereinafter, the present invention will be described in more detail by Examples thereof, which should not be construed as limiting the scope of the present invention in any way. In Examples, the units indicating contents or amounts to be used, i.e., part(s) and %, are based on weight, unless otherwise specified.

### Examples 1 to 3 and Comparative Example 1

### (a) Preparation of Coating Liquid for Primer Layer

(a1) Coating Liquid for Primer Layer Used in Examples 1 to 3

A coating liquid for a primer layer of Examples 1 to 3 was prepared by compounding “Orgatics TC” series manufactured by Matsumoto Pharmaceutical Manufacture Co., Ltd. (“Orgatics TC” being a trade name) as a curing agent containing an organic titanium compound, and “PVA-403” (trade name, saponification degree: 78.5 to 81.5% by mole) which is a partially saponified polyvinyl alcohol manufactured by KURARAY CO., LTD. as a polyvinyl alcohol resin, in the following composition.

### Composition of Coating Liquid for a Primer Layer in Examples 1 to 3

| | | |
|---|---|---|
| Water | 100 | parts |
| Organic titanium compound “Orgatics TC” series | 0.2 | part |
| Polyvinyl alcohol “PVA-403” | 15 | parts |

This coating liquid was prepared by mixing the polyvinyl alcohol “PVA-403” with water while heating at 80° C., stirring the mixture and cooling the mixture to room temperature, further adding an organic titanium compound “Orgatics TC” series to the mixture, followed by mixing and stirring to obtain the coating liquid. Specific organic titanium compounds used in Examples 1 to 3 were as follows. In Examples 1 to 3, the compound itself was the same but only the solvents were different. As described below, the organic titanium compound was obtained in the form of a solution, and an amount of the organic titanium compound used for the preparation of the above-mentioned coating liquid for a primer layer is expressed by a weight of a solution itself.

### Example 1

### “Orgatics TC-300” (Trade Name)

Chemical structure: (HO)₂Ti[OCH(CH₃)COOH]₂; a solution containing 42% by weight of the active component, 38% by weight of isopropyl alcohol and 20% by weight of water.

### Example 2

### “Orgatics TC-310” (Trade Name)

Chemical structure: (HO)₂Ti[OCH(CH)₃COOH]₂; a solution containing 44% by weight of the active component, 40% by weight of isopropyl alcohol and 16% by weight of water.

### Example 3

### “Orgatics TC-315” (Trade Name)

Chemical structure: (HO)₂Ti[OCH(CH₃)COOH]₂; a solution containing 44% by weight of the active component and 56% by weight of water.

(a2) Coating Liquid for Primer Layer Used in Comparative Example 1

A coating liquid for a primer layer of Comparative Example 1 was prepared by compounding “SUMIREZ RESIN 650(30)” (trade name, an aqueous solution having a solid content of 30%) which is a polyamide epoxy resin manufactured by Sumika Chemtex Co., Ltd. as a water-soluble curing agent, and “PVA-403” (trade name, saponification degree: 78.5 to 81.5% by mole) which is a partially saponified polyvinyl alcohol manufactured by KURARAY CO., LTD. as a polyvinyl alcohol resin, in the following composition. The amount of “SUMIREZ RESIN 650(30)” is expressed by a weight of an aqueous solution of 30% concentration itself.

### Composition of Coating Liquid for Primer Layer in Comparative Example 1:

| | | |
|---|---|---|
| Water | 100 | parts |
| Polyamide epoxy resin “SUMIREZ RESIN 650(30)” | 7.5 | parts |
| Polyvinyl alcohol “PVA-403” | 15 | parts |

### (b) Preparation of Coating Liquid for Coating Retardation Layer

As an organically modified clay complex, “LUCENTITE STN” (trade name) manufactured by CO-OP CHEMICAL CO., LTD. was used. “LUCENTITE STN” is a complex of synthesized hectorite and trioctylmethylammonium ion. As the binder resin, “SBU Lacquer 0866” (trade name) manufactured by Sumika Bayer Urethane Co., Ltd. was used. “SBU Lacquer 0866” is an isophorone diisocyanate-based urethane resin and a resin varnish having a solid content of 30%. A coating liquid for a coating retardation layer was prepared by mixing these components in the following composition.

### Composition of Coating Liquid for Coating Retardation Layer:

| | |
|---|---|
| Urethane resin vanish “SBU Lacquer 0866” | 16.0 parts |
| Organically modified clay complex “LUCENTITE STN” | 7.2 parts |
| Toluene | 76.8 parts |
| Water | 0.3 part |

The organically modified clay complex herein used was available as such prepared by the manufacturer, by washing a synthesized hectorite with an acid before organically modifying the same, organically modifying the washed hectolite, and further washing the modified hectorite with water. The chlorine content of the organically modified clay complex was 1,111 ppm. This coating liquid was prepared by mixing the components in the above-described composition, stirring the mixture and filtering the same through a filter of a pore size of 1 μm, and the water content measured with a Karl Fischer's moisture meter was 0.25%. A solid content of the organically modified clay complex to the binder resin in this coating liquid was 6:4 (by weight).

### (c) Fabrication of Composite Retardation Plate

Each of four kinds of the above-mentioned coating liquids for a primer layer was applied to a retardation plate which was a uniaxially oriented film of a norbornene resin [“CSES 430120Z-F-KY” (trade name) manufactured by Sumitomo Chemical Co., Ltd.; in-plane phase difference: 120 nm] and was dried at 80° C. for about 1.5 minutes to form a primer layer having a thickness of about 2 μm. Next, the above-mentioned coating liquid for a coating retardation layer was applied onto the primer layer and was then dried at 90° C. for 3 minutes to form a coating retardation layer to obtain a composite retardation plate consisting of the resin retardation plate/primer layer/coating retardation layer laminated in this order. With the obtained composite retardation plate, it was tried to peel off the three layers but the three layers were not peeled off and were adhered to one another at adequate strength even when using any of the coating liquids for a primer layer.

### (d) Fabrication of Composite Optical Member

A polyvinyl alcohol/iodine-based polarizing plate [“SRW 062AP6-HC2” manufactured by Sumitomo Chemical Co., Ltd. (trade name)] having a pressure-sensitive adhesive applied thereto was laminated, at its pressure-sensitive adhesive layer side, on the surface of the resin retardation plate side of the composite retardation plate obtained in the above step (c) to fabricate a composite optical member consisting of the lamination of the polarizing plate/pressure-sensitive adhesive layer/resin retardation plate/primer layer/coating retardation layer laminated in this order.

### (e) Evaluation of Composite Optical Member

(e1) Evaluation of Water Resistance

The composite optical member fabricated in the above step (d) was immersed in warm water of 60° C. for 30 minutes and was pulled out, and its edges were observed with a microscope, and consequently, a portion at which the primer layer was dissolved and lost was observed. Consequently, the maximum distance from the edge of the dissolved portion of the primer layer was determined to evaluate water resistance. The results are shown in Table 1.

TABLE 1
Results of Water Resistance Evaluation

| | | Distance from edge of |
|---|---|---|
| | | dissolved portion of |
| | | primer layer |
| Example No. | Curing agent | (Maximum value) |
| Example 1 | Orgatics TC-300 | 0.4 mm |
| Example 2 | Orgatics TC-310 | 0.4 mm |
| Example 3 | Orgatics TC-315 | 0.5 mm |
| Comparative | SUMIREZ RESIN | 1.0 mm |
| Example 1 | 650(30) | |

(e2) Evaluation of Light Leakage Attributed to Cracking of Coating Retardation Layer Due to External Force

The composite optical member fabricated in the above step (d) was laminated, at its coating retardation layer side, on a glass plate through an acrylic pressure-sensitive adhesive. Thereafter, a pencil with a hardness of H was pressed down onto the polarizing plate side of the composite optical member using a pencil hardness tester. A load on the pencil was increased to evaluate light leakage attributed to cracking of the coating retardation layer due to an external force. In this test, another polarizing plate was disposed on the opposite surface of the glass plate having the composite optical member laminated on its one surface, so that another polarizing plate could be in a crossnicol state with the polarizing plate of the composite optical member. Then, light leakage from this laminated sample was checked on a light box. As a result, no light leakage occurred even under a load of 2.0 kg as the limit of loading when any of the coating liquids for a primer layer was used.

### Examples 4 to 10 and Comparative Example 2

### (a) Preparation of Coating Liquid for Primer Layer

(a1) Coating Liquid for Primer Layer Used in Examples 4 to 10

A coating liquid for a primer of Examples 4 to 10 was prepared by compounding “KL-506” (trade name, saponification degree 74 to 80% by mole) which is an anion-modified partially saponified polyvinyl alcohol manufactured by KURARAY CO., LTD. as a water-soluble resin, “Orgatics TC-310” which is the same as used in Example 2 as a curing agent containing a water-soluble organic titanium compound, and further, in Examples 9 and 10, “SUMIREZ RESIN 650(30)” (trade name, an aqueous solution having a solid content of 30%) which is the same polyamide epoxy resin used in Comparative Example 1 as the second curing agent, and water alone or water and isopropanol (abbreviated as “IPA” in Table) mixed in a weight ratio of 85:15 as a solvent, in the following composition. However, the amounts of the organic titanium compound “Orgatics TC-310” and the polyamide epoxy resin “SUMIREZ RESIN 650(30)” are shown as a weight of a solution in Table 2.

### Composition of Coating Liquid for Primer Layer in Examples 4 to 10:

| | |
|---|---|
| Solvent | 100 parts |
| (water alone or mixture of water and isopropanol) | |
| Anion-modified polyvinyl alcohol “KL-506” | 15 parts |
| Organic titanium compound “Orgatics TC-310” | (see Table 2) |
| Polyamide epoxy resin “SUMIREZ RESIN 650(30)” | (see Table 2) |

(a2) Coating Liquid for Primer Layer Used in Comparative Example 2

A coating liquid for a primer layer of Comparative Example 2 was prepared by compounding “KL-506” (trade name, saponification degree: 74 to 80% by mole) which is an anion-modified partially saponified polyvinyl alcohol manufactured by KURARAY CO., LTD. as a water-soluble resin, and “SUMIREZ RESIN 650(30)” (an aqueous solution having a solid content of 30%) which is the same polyamide epoxy resin used in Comparative Example 1 as a water-soluble curing agent, in the following composition.

### Composition of Coating Liquid for Primer Layer Used in Comparative Example 2:

| | | |
|---|---|---|
| Water | 100 | parts |
| Anion-modified polyvinyl alcohol “KL-506” | 15 | parts |
| Polyamide epoxy resin “SUMIREZ RESIN 650(30)” | 7.5 | parts |

### (b) Preparation and Evaluation of Composite Retardation Plate

A composite retardation plate was fabricated in the same manner as in the step (c) of Examples 1 to 3 except for using the coating liquid for a primer layer prepared in the above step (a), and a composite optical member was fabricated in the same manner as in the step (d) of Examples 1 to 3 using the composite retardation plate. Furthermore, the water resistance was evaluated in the same manner as in the step (e1) of Examples 1 to 3. The results are shown in Table 2 together with the amounts of the curing agents used and the kinds of the solvents used. Then, with the composite optical member fabricated in each Example, light leakage attributed to cracking of the coating retardation layer due to an external force was evaluated in the same manner as in the step (e2) of Examples 1 to 3. As a result, no light leakage occurred even under a load of 2.0 kg as the limit of loading when any of the coating liquids for a primer layer was used.

TABLE 2
Amount of Coating Liquid for Primer Layer and Results of Water
Resistance Evaluation

| | Curing agent | | | |
|---|---|---|---|---|
| | | Polyamide | | |
| | Organic | epoxy | | |
| | titanium | resin | | Distance from |
| | compound | SUMIREZ | | edge of dissolved |
| | Orgatics | RESIN | | portion of primer |
| Example | TC-310 | 650(30) | | layer |
| No. | (parts) | (parts) | Solvent | (Maximum value) |
| Ex. 4 | 7.5 | | Water alone | 0.2 mm |
| Ex. 5 | 15.0 | | Water alone | 0.1 mm |
| Ex. 6 | 15.0 | | Water + IPA | 0.1 mm |
| Ex. 7 | 30.0 | | Water alone | 0.0 mm |
| Ex. 8 | 30.0 | | Water + IPA | 0.0 mm |
| Ex. 9 | 3.0 | 7.5 | Water alone | 0.3 mm |
| Ex. 10 | 3.0 | 7.5 | Water + IPA | 0.3 mm |
| Comp. | — | 7.5 | Water alone | 1.0 mm |
| Ex. 2 | | | | |

### Comparative Example 3

The coating liquid for a coating retardation layer prepared in the step (b) of Examples 1 to 3 was applied to the mold-release treated surface of a polyethylene terephthalate film with a thickness of 38 μm (hereinafter, referred to as a “mold-release film”), and was then dried at 90° C. for 3 minutes to form a coating retardation layer. A retardation plate [“CSES 430120Z6-F8-KY” (trade name) manufactured by Sumitomo Chemical Co., Ltd.] which was made of the same material as that constituting each of the resin retardation plates used in the step (c) of Examples 1 to 3 and which had the same in-plane phase difference and had a pressure-sensitive adhesive layer formed on its one side, was laminated, at its pressure-sensitive adhesive layer side, on the surface of the coating retardation layer, to form a four-layer structure consisting of resin retardation plate/pressure-sensitive adhesive layer/coating retardation layer/mold-release film. Next, the same polarizing plate, “SRW 062AP6-HC2”, having the pressure-sensitive adhesive layer formed thereon, as that used in the step (d) of Examples 1 to 3 was laminated, at its pressure-sensitive adhesive layer side, on the surface of the resin retardation plate side, to form a six-layer structure consisting of the polarizing plate/pressure-sensitive adhesive layer/resin retardation plate/pressure-sensitive adhesive layer/coating retardation layer/mold-release film. The mold-release film was peeled from the structure, and then the remaining layers were laminated at the side of the exposed coating retardation layer on a glass plate through an acrylic pressure-sensitive adhesive. In this state, the light leakage attributed to an external force was evaluated using the same pencil hardness tester as in the step (e2) of Examples 1 to 3. As a result, light leakage was observed under a load of 600 g.

### INDUSTRIAL APPLICABILITY

The composite retardation plate of the present invention can effectively suppress light leakage attributed to cracking of the coating retardation plate, liable to occur due to an external physical force when laminated on a liquid crystal cell, since the retardation plate made of a transparent resin and the coating retardation layer are laminated on each other through the primer layer, and at the same time, it can increase particularly the water resistance of the primer layer by allowing the coating liquid for a primer layer to contain a curing agent containing a water-soluble reactive organic titanium or zirconium compound together with a water-soluble resin and applying the coating liquid to form the primer layer. Accordingly, a liquid crystal display comprising a composite optical member, which is fabricated by combining this composite retardation plate with an optical layer having other optical function such as a polarizing plate, becomes superior in display conditions and also in water resistance.

1. A composite retardation plate comprising a retardation plate made of a transparent resin, a primer layer, and a coating retardation layer that comprises an organically modified clay complex and a binder resin, which are laminated in this order, wherein the primer layer is formed of a composition comprising a water-soluble resin and a water-soluble organic metal compound selected from the group consisting of water-soluble organic titanium compounds and water-soluble organic zirconium compounds.

2. The composite retardation plate according to claim 1, wherein said retardation plate made of a transparent resin comprises an in-plane oriented transparent resin film.

3. The composite retardation plate according to claim 1 or 2, wherein said water-soluble resin constituting the primer layer is a polyvinyl alcohol resin.

4. The composite retardation plate according to claim 1, wherein said composition for forming a primer layer further comprises a curing agent other than the water-soluble organic metal compound.

5. The composite retardation plate according to claim 4, wherein said curing agent other than the water-soluble organic metal compound is a water-soluble epoxy resin.

6. A process for forming a composite retardation plate, which comprises the steps of:
applying a coating liquid for a primer layer, which is prepared by dissolving a water-soluble organic metal compound selected from the group consisting of water-soluble organic titanium compounds and water-soluble organic zirconium compounds and a water-soluble resin in a solvent comprising water, onto the surface of a retardation plate made of a transparent resin,
removing the solvent therefrom to form a primer layer,
applying a coating liquid for a coating retardation layer, which contains an organically modified clay complex and a binder resin contained in an organic solvent, onto the surface of the primer layer, and
removing the solvent therefrom to form a coating retardation layer.

7. The process according to claim 6, wherein the primer layer is subjected to thermal aging at a temperature of 30 to 80° C. after applying said coating liquid for a primer layer and removing the solvent therefrom to form a primer layer.

8. A composite optical member comprising an optical layer having other optical function laminated on the composite retardation plate claimed in claim 1.

9. The composite optical member according to claim 8, wherein said optical layer includes at least a polarizing plate.

10. The composite optical member according to claim 9, wherein said polarizing plate is laminated on the coating retardation layer side of the composite retardation plate.

11. A liquid crystal display comprising a composite optical member claimed in any one of claims 8 to 10 disposed on at least one surface of a liquid crystal cell.
